(19) United States
(12) Patent Application Publication
(10) Pub. No.: US 2025/0384247 A1
(43) Pub. Date: Dec. 18, 2025

(54) PRIVACY-PROTECTING DISTRIBUTED SELF-SUPERVISED LEARNING

(71) Applicant: Google LLC, Mountain View, CA (US)

(72) Inventors: Raviteja Vemulapalli, Seattle, WA (US); Galen Michael Andrew, Seattle, WA (US); Hang Qi, Mountain View, CA (US); Hugh Brendan McMahan, Seattle, WA (US); Philip Andrew Mansfield, Penticton (CA)

(21) Appl. No.: 18/880,035

(22) PCT Filed: Jul. 1, 2022
(86) PCT No.: PCT/US2022/035953

§ 371 Date: Dec. 30, 2024

(51) Int. Cl. G06N 3/047; G06N 3/0895

(52) U.S. Cl. CPC G06N 3/047; G06N 3/0895

(57) ABSTRACT

Methods, systems, and apparatus, including medium-encoded computer program products, for receiving, from a first set of user devices, embedding statistics that were determined by the user devices using sets of one or more training pairs. Global embedding statistics can be determined, at least in part, using the embedding statistics, and transmitted to a second set of user devices. Local parameter model updates that were determined, at least in part, using the global embedding statistics can be received from the second set of user devices. Global model updates can be determined at least in part and using at least a subset of the local model updates. Global model updates can be transmitted to a third set of user devices.

### FIELD

This specification relates to training a machine learning model.

### BACKGROUND

Training a machine learning (ML) model can require a large number of training examples. For example, ML models that make predictions relating to image classification can require many thousands of image examples to attain high prediction accuracy.

Barlow Twins is a self-supervised learning method that applies redundancy-reduction to train machine learning models using unlabeled data. A machine learning model trained with this approach produces representations of input data that can be adopted to various tasks (e.g., image classification, object detection and image segmentation) using a limited number of labeled examples. An objective function measures a cross-correlation matrix between the embeddings of two identical neural networks that are provided with distorted versions of a batch of training examples (e.g., two distorted versions of a single image), and minimizes the difference between this cross-correlation matrix and the identity matrix. By causing the embedding vectors of distorted versions of an image to be similar, the model can recognize the distortions as versions of the same image while also minimizing the redundancy between the components of these vectors.

### SUMMARY

This specification relates to training a machine learning model using user devices as distributed training nodes in a manner that preserves user privacy. Rather than sending training images to a server, potentially compromising the privacy of users who captured the images, user devices send only aggregated statistical data to a server. This approach preserves the privacy of users who capture images using their user devices.

One aspect features receiving, from a first set of user devices, embedding statistics that were determined by the user devices using sets of one or more training pairs. Global embedding statistics can be determined, at least in part, using the embedding statistics, and transmitted to a second set of user devices. Local parameter model updates that were determined, at least in part, using the global embedding statistics can be received from the second set of user devices. Global model updates can be determined at least in part and using at least a subset of the local model updates. Global model updates can be transmitted to a third set of user devices.

One or more of the following features can be included. The second set of user devices can differ, at least in part, from the first set of user devices, and the second set of user devices can be selected from among user devices that are ready to train. Determining the global embedding statistics can include determining a mean of the received embedding statistics. The mean can be a weighted mean. The global model updates can be gradients. The embedding statistics can include embedding statistics for respective sets of one or more training image pairs.

Another aspect features, for one or more training pairs, each training pair including a first image and a second training example, wherein the first image and the second training example are different from each other, a first user device using a machine learning image representation model to determine embedding statistics of local embeddings based on the one or more training pairs. The first user device can provide to a server separate from the first user device, the embedding statistics. A second user device can receive from the server global embeddings that can be based on the local embeddings from the first user device and from other user devices that each determine respective local embeddings using respective sets of one or more training pairs that are each different from the one or more training pairs used by the first user device. A second user device can determine local model parameter updates for the machine learning image representation model using at least the global embeddings. The second user device can provide to the server, the local model parameter updates. A third user device can receive from the server global model parameter updates based on the local model parameter updates from the second user device and the other user devices that each determine respective local model parameter updates. The third user device can update machine learning image representation model using the global model parameters.

One or more of the following features can be included the second training example can be a second image. The first image and the second images can be augmentations of a third image, and the first image can be different from the second image due to the augmentation. The second training example can be metadata describing the first image. The first user device, the second user device and third user device can be the same user device. The local parameter model updates can include gradients.

Particular embodiments of the subject matter described in this specification can be implemented so as to realize one or more of the following advantages. The techniques described below can be used to train an image representation machine learning model using unlabeled images while preserving the privacy of users who provide training images. Images captured by a user do not leave the user's device, thereby alleviating privacy concerns. The techniques described below can further improve resource efficiency by training the machine learning model using multiple user devices that have spare computing cycles rather than a central server, which enables an efficient use of spare computer resources, resulting in a technological improvement in the field of machine learning. Example techniques described in this specification solve the technical problem of how to implement privacy-protecting self-supervised learning in a distributed or federated learning setting in which a machine learning model (e.g. an image classifier machine learning model) is trained using multiple user devices. Further, the image representations produced by the model trained using the techniques described can be used to perform tasks such as image classification, object recognition, image segmentation, image captioning, etc. using a limited amount of labeled data. In addition, the techniques described here can be used to learn representations of multi-modal data such as image-text pairs, and audio-video pairs.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows a system for privacy-protecting distributed self-supervised learning.

FIGS. 2A and 2B show examples of the computation of embedding statistics.

FIG. 3 shows a process for privacy-protecting distributed self-supervised learning.

FIG. 4 is a block diagram of an example computer system.

Like reference numbers and designations in the various drawings indicate like elements.

### DETAILED DESCRIPTION

As described above, image representation machine learning models can be trained using pairs of images that are related to an original image. For example, each image in a pair of images can be a distorted version of an original image; or an original image and an augmented version of the original image; or an original image and a label describing the original image. Other training pairs can also be used, and will be described in more detail below. Each image in a pair of images comprises a plurality of pixels which are processed by the image classification machine learning model.

User devices that include cameras and/or store images, such as many mobile telephones and tablet computers, can be a useful source of images, as many device owners use the devices to take pictures and/or store images. Further, since device owners can be geographically dispersed and often capture images of their local surroundings, and can have varied interests, the images can be quite diverse, which can aid in machine learning model training.

However, amassing a large set of images taken by users at a central server can compromise user privacy. To protect their privacy, some users prefer that their images never leave their devices, or at least never leave server accounts that they control. Such preferences make training a machine learning model using a central server the aggregates images impractical in some cases.

Barlow Twins can provide a partial answer as machine learning models trained using the Barlow Twins approach require only aggregate statistics determined from the training examples, not the training examples themselves. However, computing such statistics requires access to the images, so simply using Barlow Twins on a central computer does not improve privacy.

Rather than providing all training examples to a central training server, this specification describes techniques in which user devices compute local aggregate statistics, and provide only those aggregated statistics to a server. The server can then determine a statistical relationship (e.g., a mean) of local aggregated statistics provided by multiple user devices to create global aggregate statistics, and provide the global aggregate statistics to the user devices. Thus, user privacy is protected since the images never leave the user devices, while still enabling effective training of image representation machine learning models.

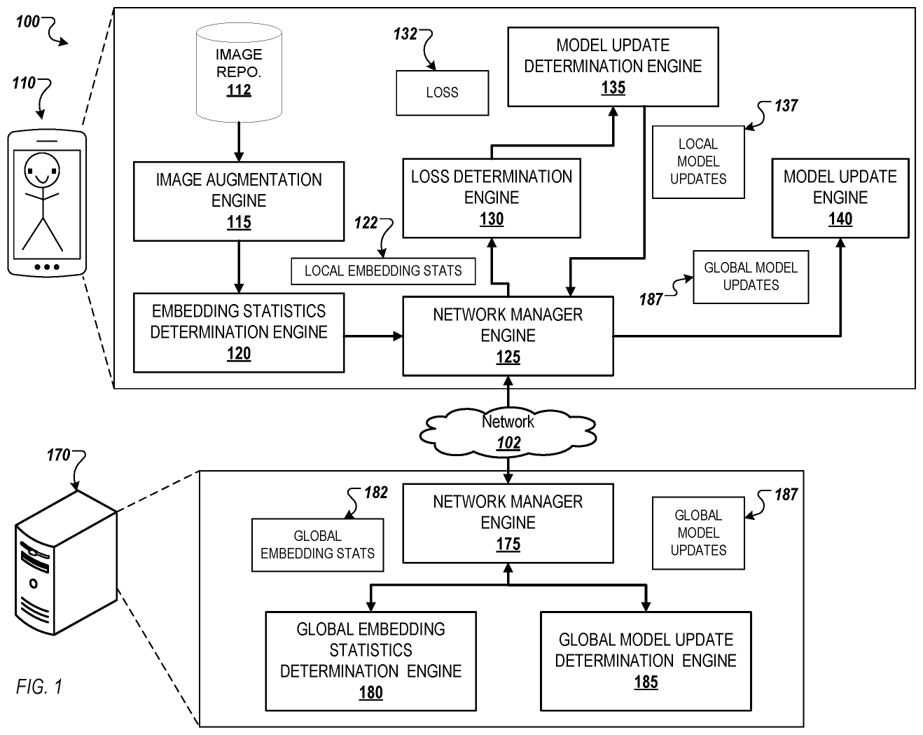

FIG. 1 shows a system 100 for privacy-protecting distributed self-supervised learning. The system 100 can include one or more user devices 110, a network 102 and one or more servers 170.

The user device 110 is a computing device that is capable of performing computations and exchanging data over the network 102. Example computing devices 110 include client devices, personal computers, mobile communication devices, wearable devices, personal digital assistants, and other devices that can send and receive data over the network 102. The user device 110 can include an image repository 112, an image augmentation engine 115, an embedded statistics determination engine 120, a network manager engine 125, a loss determination engine 130, a model update determination engine 135 and a model update engine 140.

The user device 110 can store images in the image repository 112. The image repository 112 can be storage, such as non-volatile random access memory (NV-RAM), configured to storage images on the user device 110. For example, if the user device 110 includes a camera, images captured by the camera can be stored by the user device 110 in the image repository 112. In another example, the user device 110 can obtain images over the network 102, and store the images in the image repository 112.

The image augmentation engine 115 can obtain images, e.g., from the image repository 112, as input and produce one or more augmented images that can be used to train an image representation machine learning model. Examples of image augmentations can include, without limitation, flipping the image horizontally, flipping the image vertically, shifting an image vertically and/or horizontally, rotating an image by a random or pseudorandom amount, stretching an image, overwriting random pixels with random pixel values to distort the image, and any other augmentation that can be useful for training a model. The images used by the image augmentation engine 115 can be images created by the user device 110 (e.g., using a camera that is part of or coupled to the user device) or obtained by the user device (e.g., over the network 102). The image representation machine learning model such as a convolution neural network (CNN), e.g., a U-Net.

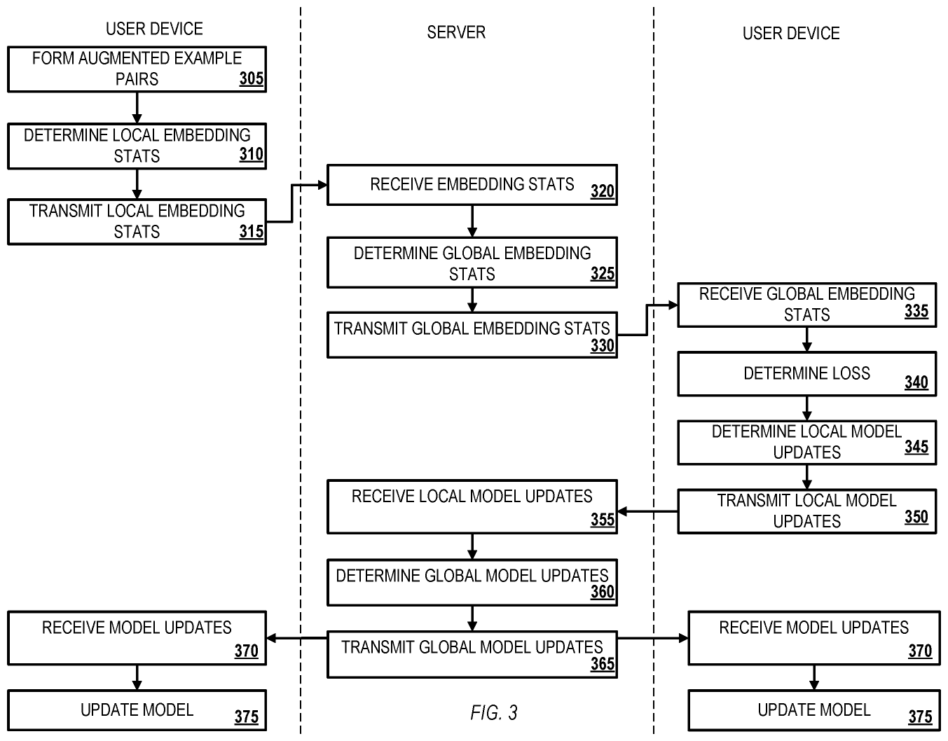

The embedding statistics determination engine 120 can accept the training data and compute embedding statistics. The training data can be a pair of samples such as the original image and an augmented version of the image, two augmented versions of an image, the original image and metadata for the image (e.g., descriptive text such a caption), and an augmented version of the image and metadata, e.g., a label, for the image. Typically the training pairs will either be image pairs or an image paired with metadata. For training involving image pairs, different combinations of original and augmented images can be used as training pairs. The embedding statistics determination engine 120 can compute local embedding statistics 122 as described further in reference to FIG. 3.

The network manager engine 125 can communicate with other user devices 110 and with the server 170 over the network 102 such as a local area network (LAN), a wide area network (WAN), the Internet, or a combination thereof, or over a direct connection, such as an Ethernet or fiber optic cable. The network manager engine 125 can communicate with the devices 110 over any appropriate networking protocol such as the Transport Communication Protocol/Internet Protocol (TCP/IP) or Hypertext Transfer Protocol (HTTP). The network manager engine 125 can receive images, transmit local embedding statistics 122 and local model updates 137, and receive global embedding statistics 182 and global model updates 187.

The loss determination engine 130 can accept global embedding statistics 182 produced by the server 170 and local embedding statistics 122, and use those statistics to compute loss values 132, as described further in reference to FIG. 3. The loss determination engine 130 can provide the loss values 132 to the model update determination engine 135.

The model update determination engine 135 can accept the loss values 132, local embedding statistics 122, and global embedding statistics 182 and can determine local model updates 137. In some examples, the model update determination engine 135 can also instruct the embedding statistics determination engine 120 to produce additional local embedding statistics 122, as described further below.

The model update engine 140 can accept global model updates 187 and create an updated local model. Local model updates 137 and global model updates 187 can be gradients (e.g., computed using gradient descent) and encoded as matrices, one per layer of the network. The server 170 can include a network manager engine 175, a global embedded statistics determination engine 180 and a model update determination engine 185. The network manager engine 127 can communicate with other servers 170 and with user devices 110 over the network 102. The network manager engine 175 can receive local embedding statistics 122 and local model updates 137, and transmit global embedding statistics 182 and global model updates 187.

The global embedded statistics determination engine 180 can accept local embedding statistics 122 from multiple user devices 110 and determine statistical tendencies for the set of local embedding statistics 122, as described further below. The global embedded statistics determination engine 180 can provide the resulting global embedding statistics 182 to the network manager engine 175 for transmission to user devices 110.

The global model update determination engine 185 can accept local model updates 137 from multiple user devices 110 and determine a statistical tendency for the set of local model updates 137, as described further below. The global model update determination engine 185 can provide the resulting global model updates 187 to the network manager engine 175 for transmission to user devices 110.

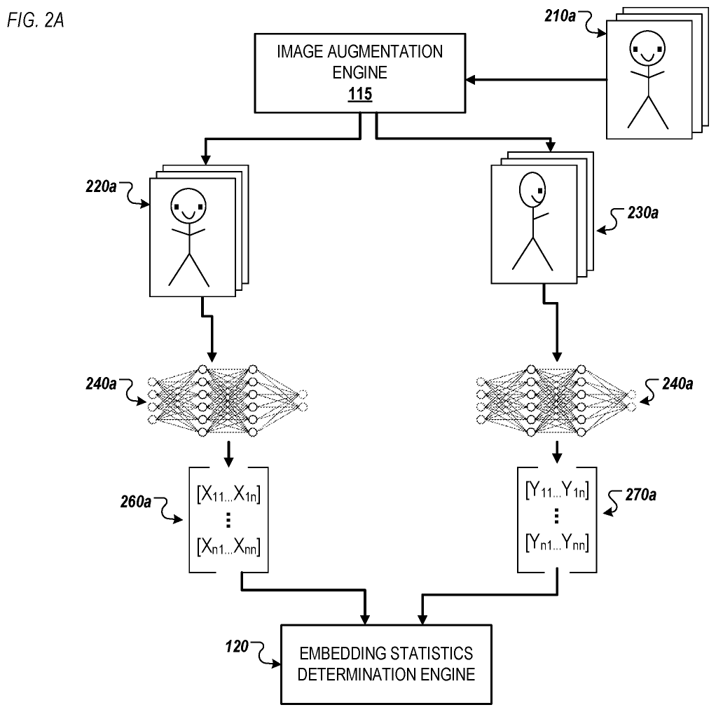

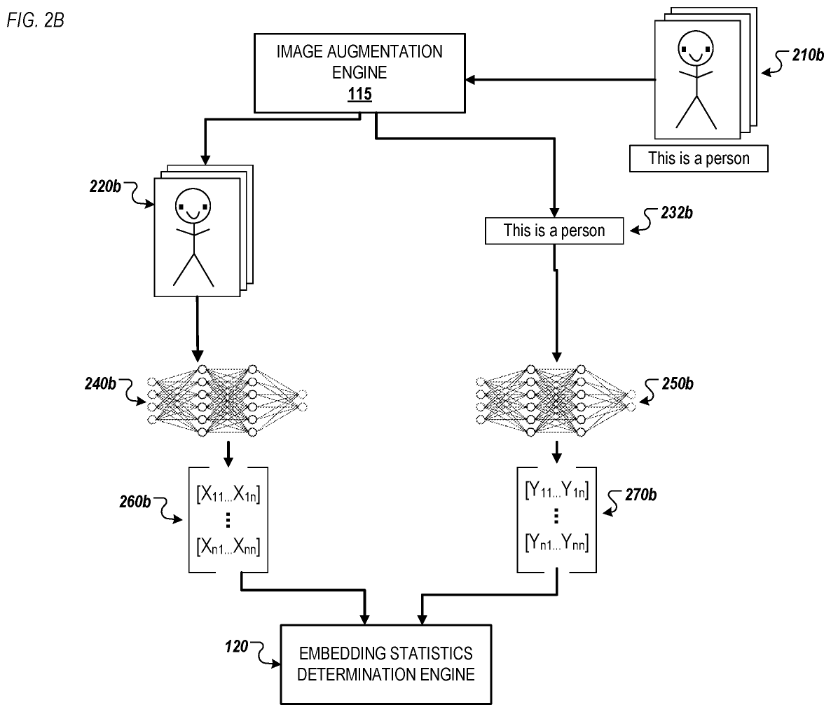

FIG. 2A shows a first example of the computation of embedding statistics. A user device can provide one or more images 210a to an image augmentation engine 115. As described above, the image augmentation engine 115 can produce a pair of images that includes one or more augmented versions 230a of the original image 220a. In some implementations, the image augmentation engine 115 produces the original image 220a and one augmented version of the image 230a, as illustrated in FIG. 2A. In some implementations, the image augmentation engine 115 produces two augmented versions of the image 230a. In either case, the image augmentation engine 115 provides each image of the pair of images to a machine learning model 240a, and the machine learning model 240a produces embeddings 260a, 270a for each image. As described above, the machine learning model 240a can be an image representation model such as a CNN. The embeddings 260a, 270a are used by the embedding statistics determination engine 120, which determines the embedding statistics 120, as described further in reference to FIG. 3.

FIG. 2B shows a second example of the computation of embedding statistics. A user device can provide one or more images 210b to an image augmentation engine 115. In this example, the image augmentation engine 115 can produce a training example pair that includes an image 220b and metadata 232b describing the image. The metadata can be added by a user, generated by some other process, or otherwise be extant with the image. The image 220b can either be the original version of the image or an augmented version of the image. In either case, the image augmentation engine 115 provides each training example (which includes an image and metadata 232b) to a machine learning model 240b, and the machine learning model 240b produces embeddings 260b, 270b for each image. The embeddings 260b, 270b are used by the embedding statistics determination engine 120, which determines the embedding statistics 120, as described further in reference to FIG. 3.

FIG. 3 shows a process for privacy-protecting distributed self-supervised learning. For convenience, the process 300 will be described as being performed by a system for privacy-protecting distributed self-supervised learning, e.g., the system for privacy-protecting distributed self-supervised learning system 100 of FIG. 1, appropriately programmed to perform the process. Operations of the process 300 can also be implemented as instructions stored on one or more computer readable media which may be non-transitory, and execution of the instructions by one or more data processing apparatus can cause the one or more data processing apparatus to perform the operations of the process 300. One or more other components described herein can perform the operations of the process 300.

The user device forms (305) augmented example pairs, X and Y. In various implementations, the examples pairs are: (i) the original image and an augmentation of the original image; (ii) two augmentations of the original image; (iii) the original image and metadata associated with the original image; and (iv) an augmentation of the original image and metadata associated with the image. One example of metadata is a caption for the image. As described above examples of image augmentations can include, without limitation, flipping, shifting, rotating and stretching the image.

The user device determines (310) local embedding statistics. The local embedding statistics are computed by first evaluating each of X and Y using the same embedding network (or identical copies of an embedding network if both X and Y are images, and different networks if X and Y are used for different input types, such as image and text) to produce embedding vector F for X and embedding vector G for Y. The network can be obtained using various techniques including retrieving the network from storage (e.g., a file system or relational database) or by receiving it from the server (e.g., by receiving one or more messages from the server that include the network).

The loss function is computed by minimizing the pairwise correlation coefficient-based loss function:

$${ℒ}_{β τ} = {\sum }_{i = 1}^{d} {( 1 - {C}_{ii} )}^{2} + λ {\sum }_{1}^{d} {\sum }_{j = 1 , j \neq i}^{d} {C}_{ij}^{2} \qquad ( 1 )$$

Cᵢⱼ represents the correlation coefficient between the i^{th} component of F and the j^{th} component of G. Cᵢⱼ can be computed as:

$$\begin{matrix}{C}_{ij} = \frac{Covariance ( {F}_{i} , {G}_{j} )}{Std ( {F}_{i} ) Std ( {G}_{j} )} \\ = \frac{𝔼 [ {F}_{i} {G}_{j} ] - 𝔼 [ {F}_{i} ] 𝔼 [ {G}_{j} ]}{\sqrt{𝔼 [ {F}_{i}^{2} ] - {( 𝔼 [ {F}_{i} ] )}^{2}} \sqrt{𝔼 [ {G}_{j}^{2} ] - {( 𝔼 [ {G}_{j} ] )}^{2}}}\end{matrix} \qquad ( 2 )$$

( [symbol] is the mathematical expectation function.)

Therefore, the loss, [symbol] , is a function of the embedding statistics,

$${\{ 𝔼 [ {F}_{i} ] \}}_{i = 1}^{d} , {\{ 𝔼 [ {F}_{i}^{2} ] \}}_{i = 1 ,}^{d} , {\{ 𝔼 [ {G}_{j} ] \}}_{j = 1}^{d} , {\{ 𝔼 [ {G}_{j}^{2} ] \}}_{j = 1}^{d} , and {\{ 𝔼 [ {F}_{i} {G}_{j} ] \}}_{i , j = 1}^{d} ,$$

rather than a function of the individual embeddings,

$${\{ {F}^{k} , {G}^{k} \}}_{k = 1}^{K} .$$

The user device transmits (315) the local embedding statistics to the server. The system can send local embedding statistics using any appropriate transmission protocol. For example, the system can send the digital component over a network using HTTP, HTTPS or TCP/IP. In some implementations, the user device can transmit the local embedding statistics by calling an application programming interface (API) provided by the server. The API can be configured to receive the local embedding statistics. As noted above, the local embedding statistics are

$${\{ 𝔼 [ {F}_{i} ] \}}_{i = 1}^{d} , {\{ 𝔼 [ {F}_{i}^{2} ] \}}_{i = 1 ,}^{d} , {\{ 𝔼 [ {G}_{j} ] \}}_{j = 1}^{d} , {\{ 𝔼 [ {G}_{j}^{2} ] \}}_{j = 1}^{d} , and {\{ 𝔼 [ {F}_{i} {G}_{j} ] \}}_{i , j = 1}^{d} .$$

In some implementations, the user device can also transmit metadata, e.g., the number of examples used to produce the embedding statistics.

The server receives (320) the local embedding statistics from user devices. The server can receive the local embedding statistics using the protocol selected by the user device. For example, if the user device transmitted the message using TCP/IP, the server can receive the message over a TCP/IP socket. In some implementations, the server continues receiving local embedding statistics until it has received local embedding statistics from all user devices producing embedding statistics in the training interval. In some implementations, the server continues receiving local embedding statistics until it has received local embedding statistics from a number of user devices that satisfies a configured threshold.

The server determines (325) global embedding statistics. The server can compute a statistical tendency for the received local embedding statistics. In various implementations, the server can computes: (i) the mean of the received local embedded statistics; (ii) a mean weighted by the number of examples used by each user device to compute the local embedding statistics; (iii) the median of the received local embedding statistics; and (iv) a median weighted by the number of examples used by each user device to compute the local embedding statistics. Other statistical tendencies can also be used.

The server can determine the global embedding statistics once it has received local embedding statistics from all clients participating in global model training, or once it has received local embedding statistics from a configured number of clients.

The server transmits (330) the global embedding statistics. The server can use any appropriate transmission protocol. In some implementations, the server can determine user devices that are ready to train, and transmit the global embedding statistics to those user devices. For example, the server can receive from user devices indications that they are available to train, and the server can transmit the global embedding statistics to those user devices, or to a subset of those user devices. In some implementations, to avoid imposing too high a computational burden, the server can exclude all user devices that provided local embedding statistics, and transmit the global embedding statistics only to clients that did not provide local embedding statistics. In some implementations, the server can exclude clients for a configured number of training iterations, where a training iteration can include providing local embedding statistics or providing local model updates (as described further below). Further, while FIG. 3 shows separate user devices, in some implementations, the server can transmit the global embedding statistics to the same user devices that transmitted local embedding statistics in operation 315.

The user device receives (335) the global embedding statistics. The user device can receive the global embedding statistics using the protocol selected by the server.

The user device determines (340) a loss function by applying equations (1) and (2) using the global embedding statistics received from the server.

The user device determines (345) local model updates. The user device uses the loss function (computed in operation 340) and the local embedding statistics (determined in operation 310) to perform backpropagation on the network. The result of backpropagation is a set of gradients that define the local model updates.

In implementations in which different user devices compute local embedding statistics (310) and determine (345) local model updates, the client determining (345) local models updates can first determine local embedding statistics by performing the operations of 310 on images present on the user device, and using the determined local embedding statistics for operation 345.

The user device transmits (350) the local model updates (i.e., the gradients) to the server, and the server receives (355) the local model updates from the user devices. As described above, transmission and receipt can use any appropriate transmission protocol, and gradients can be encoded as matrices for each layer of the network.

The server determines (360) global model updates. The server can compute a statistical tendency for the received local model updates. For example, the server can compute the mean of the received local model updates or a mean weighted by the number of examples used by each user device. Other statistical tendencies can also be used.

The server transmits (365) the global model updates to the user devices and the user device receives (370) the global model updates. As described above, transmission and receipt can use any appropriate transmission protocol. In some implementations, the global model updates can be adjustments to the global model, e.g., gradients. In some implementations, the global model updates can be an adjusted global model.

While FIG. 3 shows the global model update being transmitted to two user devices, the global model updates can be provided to, without limitation, (i) a single user device that determined local embedding statistics and local model updates, (ii) a user device that determined local embedding statistics or local model updates, (iii) any user device that determined local embedding statistics or local model updates, and (iv) user devices that have not previously participated in the distributed model training.

The user device updates (375) its local model by applying the global model updates (i.e., gradients) received from the server. As described above, in some implementations, the global model updates are adjustments to the global model (e.g., gradients), and the user device can apply the adjustments. In some implementations, the global model updates are an adjusted global model, and the user device can replace its version of the global model with an adjusted version of the global model.

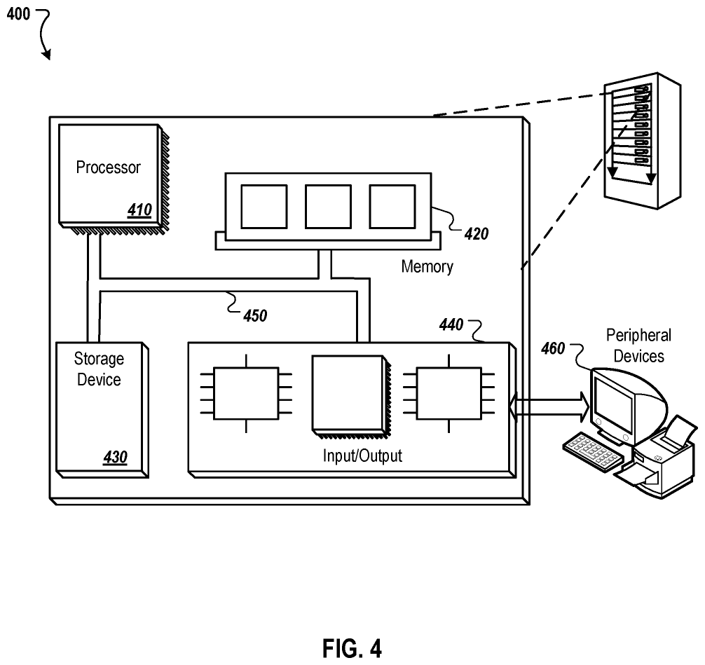

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-242 port, and/or a wireless interface device, e.g., and 802.11 card. In another implementation, the input/output device can include driver devices configured to receive input data and send output data to other input/output devices, e.g., keyboard, printer and display devices 470. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computing device capable of providing information to a user. The information can be provided to a user in any form of sensory format, including visual, auditory, tactile or a combination thereof. The computing device can be coupled to a display device, e.g., an LCD (liquid crystal display) display device, an OLED (organic light emitting diode) display device, another monitor, a head mounted display device, and the like, for displaying information to the user. The computing device can be coupled to an input device. The input device can include a touch screen, keyboard and a pointing device, e.g., a mouse or a trackball, by which the user can provide input to the computing device. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

1. A computer implemented method implemented on a server, comprising:
receiving, from a first plurality of user devices, a plurality of embedding statistics that were determined by the user devices using respective sets of one or more training pairs;
determining, at least in part using the plurality of embedding statistics, global embedding statistics;
transmitting, to a second plurality of user devices, the global embedding statistics;
receiving, from at least a subset of the second plurality of user device, local parameter model updates determined, at least in part, using the global embedding statistics;
determining, at least in part and using at least a subset of the local model updates, global model updates; and
transmitting, to a third plurality of user devices, the global model updates.

2. The computer implemented method of claim 1, wherein the second user plurality of user devices differ, at least in part, from the first plurality of user devices, and the second plurality of user device is selected from among user devices that are ready to train.

3. The computer implemented method of claim 1, wherein determining the global embedding statistics comprises determining a mean of the received embedding statistics.

4. The computer implemented method of claim 3, wherein the mean is a weighted mean.

5. The computer implemented method of claim 1, wherein the global model updates are gradients.

6. The computer implemented method of claim 1, wherein the plurality of embedding statistics comprise a plurality of embedding statistics for respective sets of one or more training image pairs.

7. A system comprising one or more computers and one or more storage devices storing instructions that when executed by the one or more computers cause the one or more computers to perform operations comprising:
receiving, from a first plurality of user devices, a plurality of embedding statistics that were determined by the user devices using respective sets of one or more training pairs;
determining, at least in part using the plurality of embedding statistics, global embedding statistics;
transmitting, to a second plurality of user devices, the global embedding statistics;
receiving, from at least a subset of the second plurality of user device, local parameter model updates determined, at least in part, using the global embedding statistics;
determining, at least in part and using at least a subset of the local model updates, global model updates; and
transmitting, to a third plurality of user devices, the global model updates.

8. The system of claim 7, wherein the second user plurality of user devices differ, at least in part, from the first plurality of user devices, and the second plurality of user device is selected from among user devices that are ready to train.

9. The system of claim 7, wherein determining the global embedding statistics comprises determining a mean of the received embedding statistics.

10. The system of claim 9, wherein the mean is a weighted mean.

11. The system of claim 7, wherein the global model updates are gradients.

12. The system of claim 7, wherein the plurality of embedding statistics comprise a plurality of embedding statistics for respective sets of one or more training image pairs.

13. One or more non-transitory computer-readable storage media storing instructions that when executed by one or more computers cause the one or more computers to perform operations comprising:
receiving, from a first plurality of user devices, a plurality of embedding statistics that were determined by the user devices using respective sets of one or more training pairs;
determining, at least in part using the plurality of embedding statistics, global embedding statistics;
transmitting, to a second plurality of user devices, the global embedding statistics;
receiving, from at least a subset of the second plurality of user device, local parameter model updates determined, at least in part, using the global embedding statistics;
determining, at least in part and using at least a subset of the local model updates, global model updates; and
transmitting, to a third plurality of user devices, the global model updates.

14. The one or more non-transitory computer-readable storage media of claim 13, wherein the second user plurality of user devices differ, at least in part, from the first plurality of user devices, and the second plurality of user device is selected from among user devices that are ready to train.

15. The one or more non-transitory computer-readable storage media of claim 13, wherein determining the global embedding statistics comprises determining a mean of the received embedding statistics.

16. The one or more non-transitory computer-readable storage media of claim 15, wherein the mean is a weighted mean.

17. The one or more non-transitory computer-readable storage media of claim 13, wherein the global model updates are gradients.

18. The one or more non-transitory computer-readable storage media of claim 13, wherein the plurality of embedding statistics comprise a plurality of embedding statistics for respective sets of one or more training image pairs.

19. A computer implemented method implemented on one or more user devices, comprising:
for one or more training pairs, each training pair comprising a first image and a second training example, wherein the first image and the second training example are different from each other:
determining, by a first user device and using a machine learning image representation model, embedding statistics of local embeddings based on the one or more training pairs;
providing, from the first user device to a server separate from the first user device, the embedding statistics;
receiving, from the server, at a second user device, global embeddings that are based on the local embeddings from the first user device and a plurality of other user devices that each determine respective local embeddings using respective sets of one or more training pairs that are each different from the one or more training pairs used by the first user device;
determining, at the second user device, local model parameter updates for the machine learning image representation model using at least the global embeddings;
providing, from the second user device to the server, the local model parameter updates;
receiving, from the server, at a third user device, global model parameter updates based on the local model parameter updates from the second user device and the plurality of other user devices that each determine respective local model parameter updates; and
updating, by the third user device, the machine learning image representation model using the global model parameters.

20. The computer implemented method of claim 19, wherein the second training example is a second image.

21. The computer implemented method of claim 20, wherein the first image and the second images are augmentations of a third image, and the first image is different from the second image due to the augmentation.

22. The computer implemented method of claim 19, wherein the second training example is metadata describing the first image.

23. The computer implemented method of claim 19, wherein the first user device, the second user device and third user device are the same user device.

24. The computer implemented method of claim 19, wherein the local parameter model updates comprise gradients.

25. A system comprising one or more computers and one or more storage devices storing instructions that when executed by the one or more computers cause the one or more computers to perform operations comprising:
for one or more training pairs, each training pair comprising a first image and a second training example, wherein the first image and the second training example are different from each other:
determining, by a first user device and using a machine learning image representation model, embedding statistics of local embeddings based on the one or more training pairs;
providing, from the first user device to a server separate from the first user device, the embedding statistics;
receiving, from the server, at a second user device, global embeddings that are based on the local embeddings from the first user device and a plurality of other user devices that each determine respective local embeddings using respective sets of one or more training pairs that are each different from the one or more training pairs used by the first user device;
determining, at the second user device, local model parameter updates for the machine learning image representation model using at least the global embeddings;
providing, from the second user device to the server, the local model parameter updates;
receiving, from the server, at a third user device, global model parameter updates based on the local model parameter updates from the second user device and the plurality of other user devices that each determine respective local model parameter updates; and
updating, by the third user device, the machine learning image representation model using the global model parameters.

26. The system of claim 25, wherein the second training example is a second image.

27. The system of claim 26, wherein the first image and the second images are augmentations of a third image, and the first image is different from the second image due to the augmentation.

28. The system of claim 25, wherein the second training example is metadata describing the first image.

29. The system of claim 25, wherein the first user device, the second user device and third user device are the same user device.

30. The system of claim 25, wherein the local parameter model updates comprise gradients.

31. One or more non-transitory computer-readable storage media storing instructions that when executed by one or more computers cause the one or more computers to perform operations comprising:
for one or more training pairs, each training pair comprising a first image and a second training example, wherein the first image and the second training example are different from each other:
determining, by a first user device and using a machine learning image representation model, embedding statistics of local embeddings based on the one or more training pairs;
providing, from the first user device to a server separate from the first user device, the embedding statistics;
receiving, from the server, at a second user device, global embeddings that are based on the local embeddings from the first user device and a plurality of other user devices that each determine respective local embeddings using respective sets of one or more training pairs that are each different from the one or more training pairs used by the first user device;
determining, at the second user device, local model parameter updates for the machine learning image representation model using at least the global embeddings;
providing, from the second user device to the server, the local model parameter updates;
receiving, from the server, at a third user device, global model parameter updates based on the local model parameter updates from the second user device and the plurality of other user devices that each determine respective local model parameter updates; and
updating, by the third user device, the machine learning image representation model using the global model parameters.

32. The one or more non-transitory computer-readable storage media of claim 31, wherein the second training example is a second image.

33. The one or more non-transitory computer-readable storage media of claim 32, wherein the first image and the second images are augmentations of a third image, and the first image is different from the second image due to the augmentation.

34. The one or more non-transitory computer-readable storage media of claim 31, wherein the second training example is metadata describing the first image.

35. The one or more non-transitory computer-readable storage media of claim 31, wherein the first user device, the second user device and third user device are the same user device.

36. The one or more non-transitory computer-readable storage media of claim 31, wherein the local parameter model updates comprise gradients.
